(19) United States
(12) Patent Application Publication
(10) Pub. No.: US 2013/0216775 A1
(43) Pub. Date: Aug. 22, 2013

(54) OPTICAL MEMBER AND IMAGING APPARATUS

(71) Applicants: Akira Sugiyama, Yokohama-shi (JP); Zuyi Zhang, Yokohama-shi (JP); Yoshinori Kotani, Yokohama-shi (JP); Kenji Takashima, Tokyo (JP); Naoyuki Koketsu, Kawasaki-shi (JP)

(72) Inventors: Akira Sugiyama, Yokohama-shi (JP); Zuyi Zhang, Yokohama-shi (JP); Yoshinori Kotani, Yokohama-shi (JP); Kenji Takashima, Tokyo (JP); Naoyuki Koketsu, Kawasaki-shi (JP)

(73) Assignee: CANON KABUSHIKI KAISHA, Tokyo (JP)

(21) Appl. No.: 13/881,006

(22) PCT Filed: Nov. 1, 2011
(86) PCT No.: PCT/JP2011/075650

§ 371 Date: Apr. 23, 2013

(30) Foreign Application Priority Data
Nov. 26, 2010 (JP) 2010-263754
Jun. 30, 2011 (JP) 2011-146513
Oct. 19, 2011 (JP) 2011-230002

(51) Int. Cl. C03C 17/02

(52) U.S. Cl. CPC C03C 17/02
USPC 428/138

(57) ABSTRACT

Provided is an optical member having high strength, low reflection, and a high transmittance. The optical member includes: a transparent substrate; and a porous glass layer having a spinodal-type porous structure disposed on the transparent substrate, in which at least one of the average pore diameter of a pore formed in the porous glass layer and the average skeleton diameter of a skeleton of the porous glass layer is set so that the optical member has a transmittance of 50% or more in the wavelength region of 450 nm or more and 650 nm or less.

### TECHNICAL FIELD

The present invention relates to an optical member having a porous glass layer and an imaging apparatus using the same.

### BACKGROUND ART

In recent years, porous glass has been attracting attention and has been expected to be industrially used for, for example, an adsorbent, a microcarrier, a separation membrane, and an optical material, by harnessing its excellent features. In order to use the porous glass industrially, surface characteristics peculiar to the porous glass play important roles, and hence there are many objects to be accomplished in regard to surface strength, porosity, and pore uniformity.

On the other hand, an optical material is required to have less light scattering and less light reflection, and in order to accomplish low light reflection, there is demanded a low-refractive index material in which light reflection is suppressed by approximating the refractive index of a structural body to the refractive index of air. In the porous glass, as air is taken inside the glass, the refractive index of a structural body becomes closer to that of air, thereby being able to accomplish a low reflection characteristic. However, in general, high porosity and high strength of a structural body are in a trade-off relationship in the porous glass, and any material sufficiently satisfying the both has not been accomplished. Thus, the accomplishment of the high strength and the high porosity is demanded.

There has been reported, as a method of producing porous glass, a method involving depositing glass nanoparticles on a heated substrate, thereby forming a porous glass film (Patent Literature 1). However, the method involves a problem in that there is a difference in temperature applied to the glass nanoparticles between the vicinity of the substrate and the surface of the film, and hence the degree of particle melt-bonding at the surface of the film is small and its surface strength is not sufficiently maintained. In addition, the glass nanoparticles melt and bond to each other by heat treatment to form the film, and hence surface strength and porosity are in a trade-off relationship, and their compatibility has been very difficult.

Further, porous glass produced by taking advantage of the spinodal-type phase separation phenomenon of glass has a special continuous porous structure having pores controlled so as to have a uniform mesh hole shape and has a higher porosity compared with other porous materials. Thus, porous glass having a spinodal-type porous structure is largely expected to be used industrially.

In general, the porous glass having a spinodal-type porous structure is obtained as follows. Mother glass is subjected to heat treatment, thereby causing mesh-like phase separation so as for the heated glass to have a phase having a higher boron content than the mother glass (soluble phase) and a phase having a lower boron content than the mother glass (insoluble phase). After that, the soluble phase is selectively etched by performing treatment with an acid solution or the like to form a porous soluble phase, thereby yielding porous glass having a three-dimensional structure including a mesh-like silica skeleton.

However, the phase separation phenomenon is a phenomenon in which a nanosized, microfine three-dimensional structure is formed, and hence it is very difficult to accomplish selective etching up to the inside of glass, resulting in difficulty in yielding pores with a uniform size.

As one means for obtaining pores with a uniform size by performing selective etching sufficiently, there is given formation of glass into a thin layer. However, when thin-layered mother glass is subjected to heat treatment, thereby causing phase separation, the behavior of its constituent elements at the time of the phase separation induces the warpage of the resultant glass or the like, resulting in the deterioration of the surface precision of the glass, and hence it has been difficult to obtain an excellent porous glass thin layer. In particular, a porous glass thin layer used as an optical material is required to be capable of highly controlling the reflection and refraction of light, and hence the layer is demanded to have a high surface precision accomplished by control at a fine scale. Thus, the porous glass thin layer is not suitable as an optical material. Further, formation of a thin layer results in favorable progress of selective etching up to the inside of glass, but the formation has a problem in that the glass thin layer becomes wholly porous, leading to a reduction in the strength of the resultant structural body.

As a method of utilizing the special surface characteristics of a porous material produced by using spinodal-type phase separation, it is considered to form a porous glass layer at the surface portion of a structural body. Non Patent Literature 1 describes a method of producing a porous glass layer by causing spinodal-type phase separation in a glass body and performing etching in a soluble phase near its surface. However, when this method is adopted, it is difficult to control the degree of the progress of etching and to control the thickness of the resultant porous glass layer, and moreover, the progress of etching is apt to be irregular, easily resulting in variation in the diameters of pores. In addition, the structural body described in Non Patent Literature 1 involves limitation in its controllable refractive index, birefringent index, and the like, and hence the structural body has had a problem with the degree of freedom in optical designing.

Besides, there is reported a method of forming surface unevenness by applying a desired component onto a glass substrate, thereby causing phase separation only in the surface of the substrate (Patent Literature 2). However, this method only forms surface unevenness, and continuous pores produced by spinodal-type phase separation are not observed in the surface. Hence, the surface does not have surface characteristics specific to a spinodal structure. Further, usable substrates are restricted in this report, and hence the method has had limitation from the standpoint of the degree of freedom in optical designing when the resultant substrates are used as optical materials that require the precise control of optical physical properties such as a refractive index and a birefringent index.

### CITATION LIST

### Patent Literature

PTL 1: Japanese Patent Application Laid-Open No. S59-092923

PTL 2: Japanese Patent Application Laid-Open No. H01-317135

### Non Patent Literature

NPL 1: M. J. Minot, “J. Opt. Soc. Am.”, Vol. 66, No. 6, 1976.

### SUMMARY OF INVENTION

### Technical Problem

The present situation is that any porous glass having characteristics such as high strength and a high transmittance has not been put into practical use as an optical member.

An object of the present invention is to provide an optical member having high strength, low reflection, and a high transmittance.

### Solution to Problem

An optical member of the present invention includes: a transparent substrate; and a porous glass layer having a spinodal-type porous structure disposed on the transparent substrate, in which at least one of an average pore diameter of a pore formed in the porous glass layer and an average skeleton diameter of a skeleton of the porous glass layer is set so that the optical member has a transmittance of 50% or more in a wavelength region of 450 nm or more and 650 nm or less.

### Advantageous Effects of Invention

According to the present invention, the optical member having high strength, low reflection, and a high transmittance can be provided.

Further features of the present invention will become apparent from the following description of exemplary embodiments with reference to the attached drawings.

### BRIEF DESCRIPTION OF DRAWINGS

FIG. 1 is a schematic view illustrating one embodiment of an optical member of the present invention.

FIG. 2 is a schematic view illustrating another embodiment of the optical member of the present invention.

FIG. 3 is a schematic view illustrating an imaging apparatus of the present invention.

FIG. 4 is a graph illustrating a frequency for each image density of a porous layer having a spinodal-type porous structure.

FIG. 5 is an electron microscopic image of a cross section of a substrate and a porous glass layer in an optical member of the present invention.

FIG. 6 is an electron microscopic image of a cross section of a porous glass layer in an optical member of the present invention.

FIG. 7A is image for describing the diameter of a pore and the diameter of a skeleton.

FIG. 7B are image for describing the diameter of a pore and the diameter of a skeleton.

### DESCRIPTION OF EMBODIMENTS

Embodiments of the present invention are hereinafter shown to describe the present invention in detail, but the embodiments do not limit the scope of the present invention.

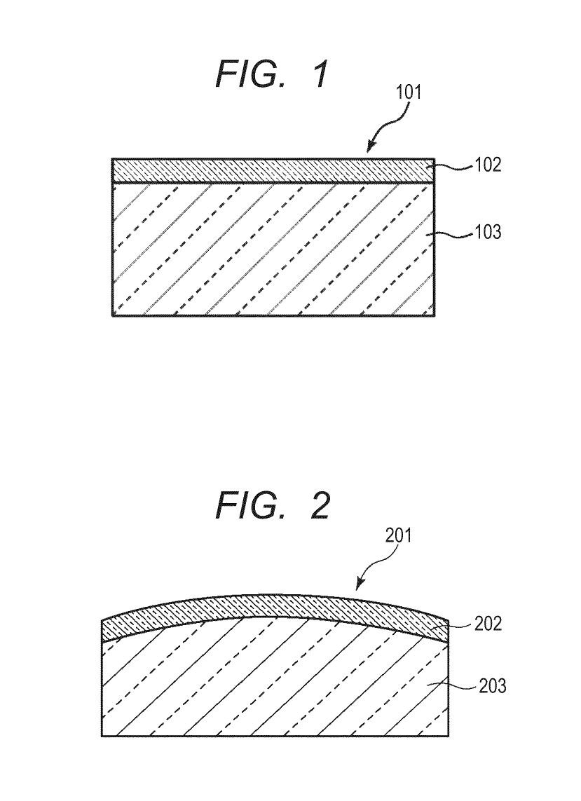

FIG. 1 is a schematic view illustrating one embodiment of a structural body of the present invention. In FIG. 1, an optical member 101 according to the present invention includes a transparent substrate 103 and a porous glass layer 102 having a spinodal-type porous structure disposed on the transparent substrate 103. The phrase “spinodal-type porous structure” means a porous structure derived from spinodal-type phase separation, and the porous structure has three-dimensionally continuous mesh hole-shaped pores. In the present invention, a porous glass layer has only to be formed on a transparent substrate, and the interface between the transparent substrate and the porous glass layer may be confirmed clearly or their clear interface may not be confirmed.

The phrase “phase separation” refers to, for example, a phenomenon in which by heating borosilicate-based glass (mother glass) formed of silicon oxide, boron oxide, and an alkali metal oxide, the inside of the glass is separated into a phase containing alkali the metal oxide and boron oxide at a smaller ratio than the mother glass (insoluble phase) and a phase containing the alkali metal oxide and boron oxide at a larger ratio than the mother glass (soluble phase) at a several nanometer scale.

The phase separation includes binodal phase separation forming non-continuous pores and spinodal-type phase separation forming continuous pores, and the present invention uses the latter phase separation. In addition, the soluble phase of a glass body obtained after phase separation (phase-separated glass) is treated with an acid solution or the like, producing a selectively etched soluble phase, thus forming a porous structure. The thus obtained spinodal-type porous structure has three-dimensional mesh hole-shaped through pores connected from its surface up to its inside, and its porosity can be arbitrarily controlled by changing heat treatment conditions.

Further, this porous structure has a skeleton in which mesh parts are bound to each other while three-dimensionally curving in a complicated manner, and hence even if the porosity of the structure is increased, the structure can have high strength. Thus, the structure can have excellent surface strength while maintaining its high porosity, and consequently, there can be provided an optical member having such a strength as to be difficult to be damaged even if the surface is touched while having excellent antireflection performance.

Further, a general porous structure is liable to have a lower transmittance owing to the influence of light scattering at its porous portions, compared with non-porous structures, and hence such general porous structure is not suitably used for optical members. However, the optical member 101 of the present invention has a construction of having a transmittance of 50% or more in the visible light region, and hence can be suitably used as an optical member. Note that the visible light region in the present invention refers to a wavelength region of 450 nm or more and 650 nm or less.

The transmittance can be increased by controlling the diameters of pores and the diameters of skeletons in the porous glass layer 102. Specifically, the average pore diameter of the pores formed in the porous glass layer 102 is 1 nm or more and 50 nm or less. When the average pore diameter is larger than 50 nm, light scattering becomes conspicuous, resulting in a huge reduction in transmittance. On the other hand, when the average pore diameter is smaller than 1 nm, it becomes difficult to perform etching in the step of forming a porous structure after phase separation. Further, when the average pore diameter is within the above-mentioned range, the strength of the resultant porous glass layer 102 is sufficiently high. Note that the average pore diameter is preferably smaller than the thickness of the porous glass layer 102.

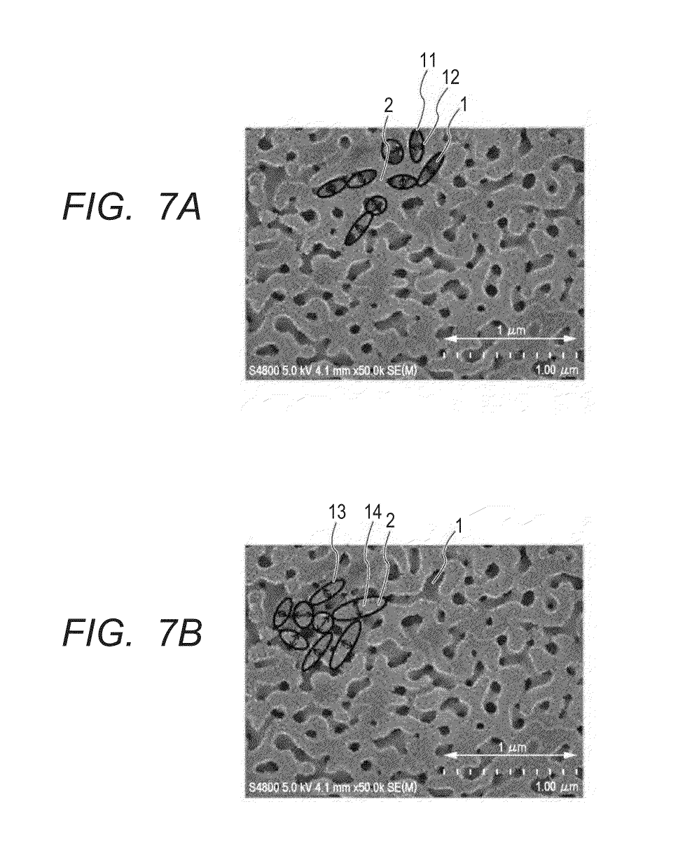

The phrase “average of pore diameters” in the present invention is defined as a value obtained by approximating pores in the surface of a porous body by multiple ellipses, and calculating the average value of the respective minor axes of the approximated ellipses. Specifically, for example, such an electron micrograph of the surface of a porous body as shown in FIG. 7A is used to approximate pores 1 by multiple ellipses 11 and calculate the average value of respective minor axes 12 of the ellipses, thereby yielding the average of pore diameters. At least 30 pores are subjected to measurement to calculate the average value of the measured values.

The average skeleton diameter of the diameters of skeletons in the porous glass layer 102 is 1 nm or more and 50 nm or less. When the average skeleton diameter is larger than 50 nm, light scattering becomes conspicuous, resulting in a huge reduction in transmittance. On the other hand, when the average skeleton diameter is smaller than 1 nm, the strength of the porous glass layer 102 is liable to be smaller.

Note that the phrase “average of skeleton diameters” in the present invention is defined as a value obtained by approximating skeletons in the surface of a porous body by multiple ellipses, and calculating the average value of the respective minor axes of the approximated ellipses. Specifically, for example, such an electron micrograph of the surface of a porous body as shown in FIG. 7B is used to approximate skeletons 2 by multiple ellipses 13 and calculate the average value of respective minor axes 14 of the ellipses, thereby yielding the average of skeleton diameters. At least 30 skeletons are subjected to measurement to calculate the average value of the measured values.

The diameters of pores and the diameters of skeletons in the porous glass layer 102 can be controlled depending on, for example, materials serving as its raw materials or heat treatment conditions at the time of performing spinodal-type phase separation.

Further, the porosity of the porous glass layer 102 is not particularly limited, and is preferably 30% or more and 70% or less, more preferably 40% or more and 60% or less. When the porosity is smaller than 30%, the advantages of being porous cannot be sufficiently exerted, and moreover, the refractive index of the porous glass layer 102 does not easily lower, and hence providing excellent low reflection characteristics is liable to be difficult. On the other hand, when the porosity is larger than 70%, the strength of the porous layer remarkably lowers.

Note that the porosity of pores may vary, if necessary, continuously or intermittently in the whole or part of the porous glass layer.

The thickness of the porous glass layer 102 is not particularly limited, and is preferably 0.05 μm or more and 200.00 μm or less, more preferably 0.10 μm or more and 50.00 μm or less. When the thickness is smaller than 0.05 μm, the thickness becomes similar to the size of each porous glass skeleton, and hence the formation of a spinodal-type porous structure is liable to be difficult. On the other hand, when the thickness is larger than 200.00 μm, providing the effect of the porous structure is liable to be difficult.

A substrate made from any material can be used as the transparent substrate 103 depending on the purposes as long as the substrate is transparent. The transmittance of the transparent substrate 103 is preferably 50% or more in the visible light region (a wavelength region of 450 nm or more and 650 nm or less), more preferably 60% or more. The material of the transparent substrate 103 is by no means limited, and examples thereof include quartz glass, quartz (crystal), sapphire, and heat-resistant glass. Of those, quartz glass and quartz (crystal) are particularly preferred from the standpoints of good transparency, heat resistance, and strength. Further, the transparent substrate 103 may be a material for a low-pass filter or a lens.

Further, any shape can be used as the shape of the transparent substrate 103, as long as the porous glass layer 102 can be formed. The shape of the transparent substrate 103 may be, for example, a lens type having a curvature as illustrated in FIG. 2.

The softening temperature of the transparent substrate 103 is preferably equal to or more than the phase separation temperature at which the spinodal-type porous structure of the porous glass layer 102 is formed, more preferably equal to or more than the temperature which is higher by 100° C. than the phase separation temperature. Note that when the transparent substrate 103 is made of crystals, the melting temperature of the crystals is set as the softening temperature. A state in which the softening temperature is lower than the temperature at which the spinodal-type porous structure of the porous glass layer 102 is formed is not preferred, because the strain of the transparent substrate 103 sometimes occurs in the step of heat treatment for phase separation. Note that the phrase “the phase separation temperature at which the spinodal-type porous structure is formed” refers to the maximum temperature among the temperatures at which a glass layer having a spinodal-type porous structure is formed.

The Young's modulus of the transparent substrate 103 is preferably 40 GPa or more. When the Young's modulus is smaller than 40 GPa, the strain of the transparent substrate 103 sometimes occurs at the time of heat treatment in the step of phase separation.

A main element forming the transparent substrate 103 is preferably the same as a main element forming the porous glass layer 102, though the above-mentioned condition by no means limits the present invention. When the main element forming the transparent substrate 103 is the same as the main element forming the porous glass layer 102, the adhesiveness between the porous glass layer 102 and the transparent substrate 103 tends to improve. In the present invention, the phrase “main element” means the element whose content is the largest among constituent elements except oxygen. The main element of porous glass is, in general, silicon, and hence it is preferred that the main element of the transparent substrate 103 also be silicon.

The content of the main element contained in the transparent substrate 103 is 20.0 atom % or more and 100.0 atom % or less, preferably 50.0 atom % or more and 100.0 atom % or less. When the content is less than 20.0 atom %, the adhesiveness between the porous glass layer 102 and the transparent substrate 103 is liable to lower. Note that the content herein refers to the content calculated based on the total amount of all elements excluding oxygen.

The transparent substrate 103 preferably has resistance to etching in the glass layer.

Further, the optical member 101 according to the present invention can be used as a low-refractive index material, because by controlling its porosity, its refractive index can be arbitrarily altered and the thickness of the porous glass layer 102 can be arbitrarily altered.

Further, in the optical member 101 of the present invention, the use of the transparent substrate 103 not only can suppress the strain of a phase-separated glass layer formed by heat treatment in the step of phase separation, but also can accomplish high strength which was not accomplished in conventional phase-separated glass alone.

In addition, in the optical member 101 of the present invention, the porous glass layer 102 is provided on the transparent substrate 103, and hence the variation in the thickness of the porous glass layer 102 caused by etching in a soluble phase tends to be small.

Moreover, in the optical member 101 of the present invention, the porous glass layer 102 is formed on the transparent substrate 103, and hence etching tends to progress uniformly in the in-plane direction, easily providing high pore uniformity, which is a feature of a spinodal-type porous structure, to the porous glass layer 102, and consequently, high design precision can be attained.

The optical member 101 of the present invention can be used as an optical member such as a polarizer used in each of various displays and liquid crystal display apparatuses of televisions and computers, a finder lens for a camera, a prism, a fly-eye lens, or a toric lens, and can be used as each of various lenses using any of them, such as an photographic optical lens, an observation optical lens such a binocular lens, a projection optical lens used in, for example, a liquid crystal projector, and a scanning optical lens used in, for example, a laser beam printer.

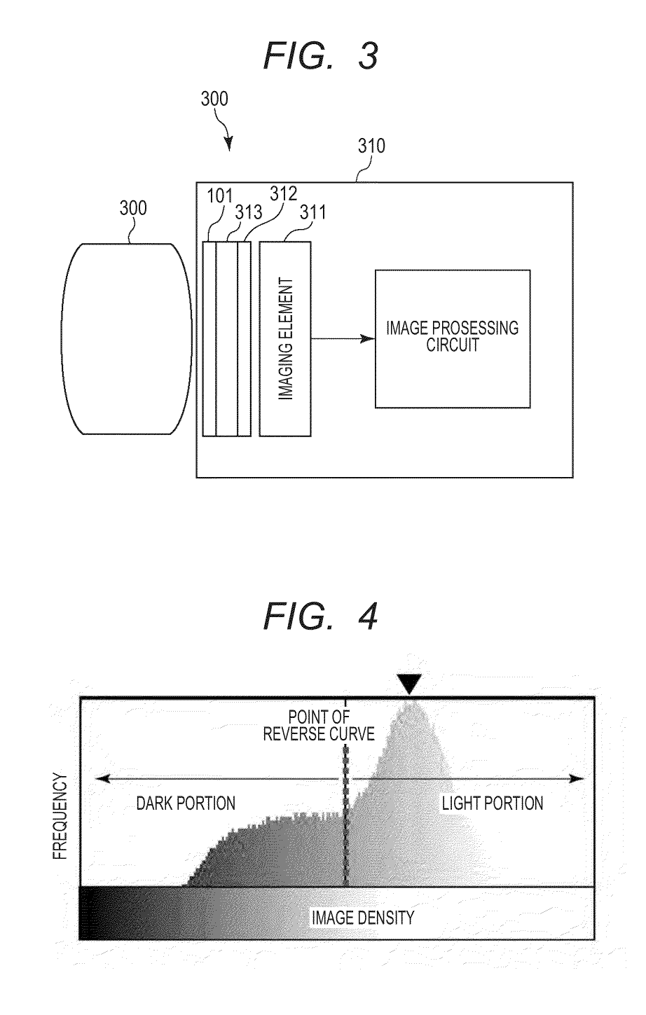

FIG. 3 is a cross sectional schematic view illustrating a camera (imaging apparatus) using an optical member of the present invention, and specifically illustrating an imaging apparatus for forming, through an optical filter, on an imaging device, an image of a subject image sent from a lens. An imaging apparatus 300 is equipped with a body 310 and a removable lens 320. An imaging apparatus such as a digital single-lens reflex camera is able to obtain shooting screens at various field angles by using each of lenses having different focal lengths while exchanging them, as a taking lens used for photographing. The body 310 has an imaging device 311, an infrared cut filter 312, a low-pass filter 313, and the optical member 101 of the present invention. Note that the optical member 101 includes the transparent substrate 103 and the porous glass layer 102 as illustrated in FIG. 1.

Further, the optical member 101 and the low-pass filter 313 may be integrally formed or may be different parts. Alternatively, the optical member 101 may be constructed so as to work also as a low-pass filter. That is, the transparent substrate 103 of the optical member 101 may be a low-pass filter.

The imaging device 311 is housed in a package (not shown) and this package keeps the imaging device 311 in a hermetically sealed state with a cover glass (not shown). In addition, the space between optical filters such as the low-pass filter 313 and the infrared cut filter 312 and the cover glass has a sealed structure (not shown) formed by using a sealing member such as a double-faced adhesive tape. Note that a case that both the low-pass filter 313 and the infrared cut filter 312 are provided as optical filters is described here, but any one of them alone may be provided as an optical filter.

The porous glass layer 102 in the optical member 101 of the present invention has a spinodal-type porous structure, and hence the layer is excellent in dust-proof performance such as suppression of dust attachment. Thus, it is preferred that the optical member 101 be disposed so as to be positioned at the opposite side of the imaging device 311 across the optical filters, and that the optical member 101 be disposed so that the porous glass layer 102 is farther from the imaging device 311 than the transparent substrate 103. In other words, it is preferred that the optical member 101 be disposed at the side closer to a lens 320 than the optical films, and that the optical member 101 be disposed so that the porous glass layer 102 is closer to the lens 320 than the transparent substrate 103.

Hereinafter, a method of producing an optical member of the present invention is described.

Examples of the method of producing an optical member of the present invention include all production methods that can be used for forming a glass layer, such as a printing method, a vacuum deposition method, a sputtering method, a spin coating method, and a dip coating method. Any of the production methods may be used as long as the used method is a production method that can accomplish the structure of the present invention.

It is essential in the present invention that a spinodal-type porous structure be formed in a porous glass layer on a transparent substrate. In order to form a spinodal-type porous structure, precise control of glass composition is necessary. It is preferred to adopt a film-forming method in which glass composition is first determined, and then a glass powder is prepared and fused, thereby forming a film, from the viewpoint of being able to perform composition control easily.

The method of producing an optical member of the present invention includes the step of forming, on a transparent substrate, a glass powder layer which at least contains a glass powder containing, as a main component, base glass prepared by mixing and melting a porous glass-producing raw material, the step of obtaining a phase-separated glass layer by performing phase separation of the glass powder layer by heat treatment at a temperature equal to or higher than the glass transition temperature of the glass powder, and the step of obtaining a porous glass layer having a spinodal-type porous structure by etching the phase-separated glass layer.

The fusion of the glass powder does not progress at a temperature lower than the glass transition temperature of the glass powder and the phase-separated glass layer does not form.

On the other hand, even if the glass powder is only simply subjected to heat treatment, phase separation does not occur sometimes, resulting in unsuccessful formation of a porous glass layer having a spinodal-type porous structure.

The inventors of the present invention have made intensive studies and have consequently found that one of the causes of the phenomenon in which a spinodal-type porous structure does not form is crystallization in the resultant glass caused by heat treatment of a glass powder. That is, the phase separation phenomenon of glass takes place in an amorphous state, and hence crystallization of glass sometimes prevents its phase separation from occurring. Besides, the inventors have found that when even partial crystallization of glass occurs, crystal portions and spinodal-type porous structure portions coexist in a porous glass layer, and light reflection due to difference in refractive index between both portions increases at their interfaces, resulting in a cause of reduction in the transmittance of the resultant optical member. The inventors of the present invention have therefore found that this crystallization can be suppressed by precisely controlling heat treatment conditions.

That is, it should be necessary to select a heat treatment method in which a layer is formed while maintaining an amorphous state at the time of fusing a glass powder, thereby forming a glass layer. Any means may be used as the heat treatment method in which a layer is formed while maintaining an amorphous state as long as the means can maintain an amorphous state. Examples thereof include a technique for suppressing the crystallization by performing heat treatment at a temperature lower than the crystallization temperature of glass and a technique for suppressing the crystallization by quenching high-temperature glass in a molten state.

Of those, a technique for suppressing the crystallization by performing heat treatment at a temperature lower than the crystallization temperature of a glass powder is preferred from the viewpoint that layer formation can be performed at lower temperatures and the viewpoint that change in the composition of glass by heat does not easily occur, thus being able to control easily the composition of glass.

Hereinafter, there is described an embodiment of the step of forming a glass powder layer which contains a glass powder containing, as a main component, base glass prepared by mixing and melting a porous glass-producing raw material of the present invention. Specifically, there is applied, on a transparent substrate, a glass paste which at least contains a solvent and a glass powder containing, as a main component, base glass prepared by mixing and melting a porous glass-producing raw material, and the solvent is then removed to form a glass powder layer.

Examples of methods of forming a glass powder layer include a printing method, a spin coating method, and a dip coating method.

A method of forming a glass powder layer containing a glass powder is hereinafter described by exemplifying a method in which a general screen printing method is used. When a screen printing method is performed, a glass powder is formed into a paste and the paste is used for printing with a screen printing machine, and hence paste adjustment is essential.

Further, the porous glass layer of the present invention is formed by phase separation of glass, and hence it is preferred to use, as a glass powder used to prepare a glass paste, mother glass whose phase separation is possible.

The material of the mother glass substrate is not particularly limited, and examples thereof include silicon oxide-based glass I (mother glass composition: silicon oxide-boron oxide-alkali metal oxide), silicon oxide-based glass II (mother glass composition: silicon oxide-boron oxide-alkali metal oxide-(alkaline earth metal oxide, zinc oxide, aluminum oxide, or zirconium oxide)), and titanium oxide-based glass (mother glass composition: silicon oxide-boron oxide-calcium oxide-magnesium oxide-aluminum oxide-titanium oxide). Of those, borosilicate-based glass of silicon oxide-boron oxide-alkali metal oxide.

Further, borosilicate-based glass contains silicon oxide at a content ratio of preferably 55.0 wt % or more and 95.0 wt % or less, particularly preferably 60.0 wt % or more and 85.0 wt % or less. When the content ratio of silicon oxide is within the above-mentioned range, a porous glass layer having high skeleton strength tends to be provided, and hence such borosilicate-based glass is useful when strength is required.

Mother glass can be produced by a known method provided that a raw material is prepared so as to have the above-mentioned content ratio. For example, mother glass can be produced by melting a raw material containing a supply source of each component under heating and forming the molten material into a desired shape, if necessary. The heating temperature at the time of the melting under heating may be arbitrarily set depending on the composition of a raw material and the like, and the temperature is in the range of usually 1,350 to 1,450° C., particularly preferably 1,380 to 1,430° C.

It is recommended that, for example, sodium oxide, boric acid, and silicon dioxide be uniformly mixed to prepare the above-mentioned raw material and the raw material be melted under heating at 1,350 to 1,450° C. In this case, any raw material may be used as long as the raw material contains the components of the above-mentioned alkali metal oxide, boron oxide, and silicon oxide.

Further, when mother glass is formed into a predetermined shape, it is recommended to synthesize mother glass and then form the mother glass into a glass product having any of various shapes such as a tube shape, a plate shape, and a spherical shape in the temperature range of about 1,000 to 1,200° C. For example, it is possible to adopt preferably a method involving melting the above-mentioned raw material to synthesize mother glass, lowering its temperature from melting temperature to 1,000 to 1,200° C., and performing shape formation while keeping the temperature.

When glass temperature is lowered from melting temperature, quenching is preferred. Quenching suppresses formation of crystal nuclei in glass, leading to easy formation of an amorphous, homogeneous powder glass layer and easy occurrence of phase separation.

Glass is powdered into a glass powder in order to use as a paste glass. It is not necessary to limit particularly a method of powdering glass, and any known powdering method can be used. Examples of the powdering method include a pulverization method in a liquid phase typified by a beads mill method and a pulverization method in a gas phase typified by a jet mill method.

The average particle diameter of glass powder particles can be arbitrarily set depending on the thicknesses of a target glass layer, and is particularly desirably 1.0 μm or more and 20.0 μm or less. This is because, when the average particle diameter is in this range, each gap between particles is smaller in the resultant powder glass layer, and the resultant porous glass layer after heat melt-bonding has a fewer defects, leading to a higher transmittance. The average particle diameter is more preferably 1.0 μm or more and 5.0 μm or less.

The formation of the glass powder layer containing glass powder is performed by using a paste containing the above-mentioned glass powder. The paste contains a thermoplastic resin, a plasticizer, a solvent, and the like together with the above-mentioned glass powder.

The ratio of the glass powder contained in the paste is desirably in the range of 30.0 wt % or more and 90.0 wt % or less, preferably 35.0 wt % or more and 70.0 wt % or less.

The thermoplastic resin contained in the paste is a component for enhancing the strength of a film after drying and for imparting flexibility to the film. As the thermoplastic resin, there may be used polybutyl methacrylate, polyvinyl butyral, polymethyl methacrylate, polyethyl methacrylate, ethyl cellulose, and the like. Those thermoplastic resins may be used alone or as a mixture of two or more thereof.

The content of the thermoplastic resin contained in the paste is preferably 0.1 wt % or more and 30.0 wt % or less. When the content is smaller than 0.1 wt %, the strength of the resultant film after drying becomes weaker, and defects and the like are produced in the resultant porous glass film at the time of melt-bonding a glass filler, sometimes leading to deterioration of its transmittance. A case where the content is larger than 30.0 wt % is not preferred, because residual components of the resin are apt to remain in glass when a glass layer is formed, sometimes leading to deterioration of its transmittance.

Examples of the plasticizer to be contained in the paste include butylbenzyl phthalate, dioctyl phthalate, diisooctyl phthalate, dicapryl phthalate, and dibutyl phthalate. Those plasticizers may each be used alone or as a mixture of two or more thereof.

The content of the plasticizer contained in the paste is preferably 10.0 wt % or less. The addition of the plasticizer allows control of drying speed and can impart flexibility to a dried film.

Examples of the solvent to be contained in the paste include terpineol, diethylene glycol monobutyl ether acetate, and 2,2,4-trimethyl-1,3-pentanediol monoisobutyrate. The solvents may each be used alone or as a mixture of two or more thereof.

The content of the solvent contained in the paste is preferably 10.0 wt % or more and 90.0 wt % or less. When the content is smaller than 10.0 wt %, providing a uniform film is liable to be difficult. On the other hand, when the content is larger than 90.0 wt %, providing a uniform film is liable to be difficult, sometimes resulting in a cause of reduction in the transmittance of the resultant optical member.

The paste can be produced by kneading the above-mentioned materials at a predetermined ratio.

The paste is applied onto a transparent substrate by using a screen printing method, followed by drying to remove a solvent component in the paste, thereby being able to form a glass powder layer containing a glass powder. Further, in order to attain a target film thickness, the glass paste may be repeatedly applied, followed by drying, any number of times.

The drying temperature and time necessary for removing a solvent can be suitably changed depending on the solvent used, and drying is preferably performed at a temperature lower than the decomposition temperature of the thermoplastic resin. When the drying temperature is higher than the decomposition temperature of the thermoplastic resin, glass particles are too densely filled to be fixed, and hence the resultant glass powder layer has more defects and larger irregularities, sometimes resulting in a cause of reduction in the transmittance of the resultant optical member.

Subsequently performed is the step of obtaining a phase-separated glass layer involving performing phase separation of the glass powder layer by heat treatment at a temperature equal to or higher than the glass transition temperature of the glass powder. Note that the glass powder layer is subjected to heat treatment, to thereby remove the thermoplastic resin and develop the fusion of the glass powder, followed by phase separation, resulting in formation of a phase-separated glass layer.

The decomposition temperature of the thermoplastic resin can be measured by using a thermogravimetric-differential thermal analyzer (TG-DTA) or the like, and the heat treatment is preferably performed at a temperature equal to or more than the decomposition temperature. When the heat treatment is performed at a temperature lower than the decomposition temperature, residual components of the resin sometimes remain in the resultant phase-separated glass layer, which is not preferred.

When the glass powder is fused, the heat treatment is preferably performed at a temperature equal to or more than its glass transition temperature. When the heat treatment is performed at a temperature lower than the glass transition temperature, the melt-bonding of the glass powder does not progress, tending not to form a glass layer.

The heat treatment temperature at which the glass powder is subjected to heat treatment is set to, for example, 200° C. or more and 1,500° C. or less, and the heat treatment time can usually be suitably set in the range of 1 hour to 100 hours, depending on the diameters of pores and the like in the resultant porous glass.

Further, it is not necessary to keep the heat treatment temperature at a constant temperature. The heat treatment temperature may be changed continuously or the heat treatment may include multiple stages with different temperatures.

Subsequently performed is the step of obtaining a porous glass layer having a spinodal-type porous structure having continuous pores, by etching the phase-separated glass layer. Specifically, non-skeletal portions are removed from the phase-separated glass layer produced in the above-mentioned heat treatment step, yielding a porous glass layer.

It is general, as means for removing non-skeletal portions, to bring glass into contact with an aqueous solution, thereby eluting a soluble phase. It is general to adopt, as means for bringing an aqueous solution into contact with glass, means involving immersing glass in an aqueous solution. It is possible to use, without any limitations, any means for bringing glass into contact with an aqueous solution, such as applying an aqueous solution to glass.

It is possible to use, as the aqueous solution, any existing solution that is capable of eluting a soluble phase, such as water, an acid solution, or an alkali solution. Besides, multiple kinds of steps of bringing glass into contact with one of these solutions may be selected depending on applications.

Acid treatment is preferably used to perform general etching in phase-separated glass in consideration of a small burden on insoluble phase portions and the degree of selective etching. Contact with an acid solution elutes and removes an alkali metal oxide-boron oxide-rich phase, which is an acid soluble component, and on the other hand, erosion of an insoluble phase is relatively small, and hence highly selective etching can be performed.

A solution of an inorganic acid such as hydrochloric acid or nitric acid is preferably used as the acid solution. It is preferred to use, as the acid solution, usually an aqueous solution, in which water is used as a solvent. It is recommended that the concentration of the acid solution be arbitrarily set usually in the range of 0.1 to 2.0 mol/L.

In the step of acid treatment, it is recommended that the temperature of the acid solution be set in the range of room temperature to 100° C. and treatment time be set to about 1 hour to 500 hours.

In general, it is preferred that treatment (etching step 1) be carried out with an acid solution, an alkali solution, or the like and water treatment (etching step 2) be then carried out. Water treatment can suppress residual components from attaching to porous glass skeletons, and consequently, porous glass having a higher porosity tends to be provided.

The temperature in the step of water treatment is preferably in the range of generally room temperature to 100° C. The time of the step of water treatment can be suitably set depending on the composition, size, and the like of glass to be treated, and is generally recommended to be set to about 1 hour to 50 hours.

Further, in the present invention, the etching step can be repeated multiple times if required.

### EXAMPLES

Next, various evaluation methods in the examples of the present invention are described.

### Method of Measuring Glass Transition Temperature (Tg) of Glass Powder

The glass transition temperature (Tg) of a glass powder is measured in a DTA curve measured with a thermogravimetric-differential thermal analyzer (TG-DTA). It is possible to use, for example, Thermo plus TG8120 (Rigaku Corporation) as a measurement apparatus.

Specifically, a platinum pan was used to heat a glass powder by increasing its temperature from room temperature at a temperature increase rate of 10° C./min to measure a DTA curve. Extrapolation was performed by a tangent method in the curve to determine the endothermic starting temperature at the endothermic peak, and the endothermic starting temperature was defined as the glass transition temperature (Tg).

### Method of Measuring Crystallization Temperature

The crystallization temperature of a glass powder in the present invention is calculated as described below.

A glass powder is subjected to heat treatment at 300° C. for 1 hour. The resultant sample was evaluated with an X-ray diffractometer (XRD). When a peak attributed to a crystal was not confirmed, a new glass powder was subjected to heat treatment at the temperature higher than 300° C. by 50° C. (at 350° C.) for 1 hour, followed by evaluation with XRD.

The operation that heat treatment was performed at a temperature higher by another 50° C. for 1 hour was repeated until crystallization was confirmed. The temperature at which a peak attributed to a crystal was confirmed was defined as the crystallization temperature. It is possible to use, for example, RINT-2100 (Rigaku Corporation) as XRD, as a measurement apparatus.

### Method of Measuring Porosity

Images of electron micrographs were subjected to binarization processing at a skeleton portion and a pore portion.

Specifically, a scanning electron microscope (FE-SEM S-4800, manufactured by Hitachi, Ltd.) is used to observe the surface of porous glass at an accelerating voltage of 5.0 kV at a magnification of 100,000 times (50,000 times in some cases), at which shading of skeletons is easily observed.

The images observed are stored as digital images and image analysis software is used to illustrate the SEM images graphically at the frequency for each image density. FIG. 4 is a graph illustrating the frequency for each image density of a porous layer having a spinodal-type porous structure. The peak portion indicated with the symbol ▾ at an image density in FIG. 4 shows a skeleton portion positioned at the front surface.

The point of reverse curve close to the peak position is defined as the threshold and the bright section (skeleton portion) and the dark section (pore portion) are binarized into black and white. The ratio of the area of the black portion to the area of the whole portion (the sum of the areas of the white and black portions) was calculated for each image, and the average value of the ratios for all images was defined as the porosity.

### Method of Measuring Pore Diameter and Skeleton Diameter

A scanning electron microscope (FE-SEM S-4800, manufactured by Hitachi, Ltd.) was used to photograph images (electron micrographs) of a porous body at an accelerating voltage of 5.0 kV at magnifications of 50,000 times, 100,000 times, and 150,000 times. Each of the photographed images was used to approximate pores in the surface of the porous body by multiple ellipses, measure the respective minor axes of 30 or more ellipses, and calculate the average value of the minor axes, thus defining the average value as the pore diameter.

Further, similarly, skeletons were approximated by multiple ellipses, the respective minor axes of 30 or more ellipses were measured, and the average value of the minor axes was calculated, thus defining the average value as the skeleton diameter.

### Method of Measuring Thickness of Porous Glass Layer

A scanning electron microscope (FE-SEM S-4800, manufactured by Hitachi, Ltd.) was used to photograph SEM images (electron micrographs) at an accelerating voltage of 5.0 kV at magnifications of from 10,000 times to 150,000 times. Each of the photographed images was used to measure the thickness of a porous glass layer portion on a transparent substrate at 30 or more sites and calculate the average value of the measured values, thus defining the average value as the thickness of a glass layer.

### Method of Measuring Main Element

The main element forming a transparent substrate and the main element forming a porous glass layer can be measured by performing the quantitative analysis of constituent elements with, for example, an X-ray photoelectron spectrometer (XPS). ESCALAB 220i-XL (manufactured by Thermo Scientific, Inc.) is used as a measurement apparatus.

A specific measurement method is described. First, element analysis is performed for the outermost surface of an optical member of the present invention with XPS, to thereby analyze the main element forming a porous glass layer.

Next, the glass layer, which is the outermost surface, is removed by an arbitrary method such as polishing. SEM or the like is used to confirm that the glass layer is removed, and then XPS measurement is again performed to analyze the main element of a transparent substrate. Alternatively, the transparent substrate portion in a cross section of an optical member is subjected to XPS measurement, thereby being able to analyze the main element of the transparent substrate.

### Method of Measuring Average Particle Diameter of Glass Powder

The average particle diameter of a glass powder can be measured by performing particle diameter measurement with an existing particle diameter measurement apparatus. Zetasizer Nano (Malvern Instruments Ltd.) is used as a measurement apparatus.

A glass powder of the present invention was dispersed in an IPA solvent to measure its average particle diameter.

The present invention is described by showing examples below, but the present invention is not restricted by the examples.

### Production Example of Glass Powder 1

A mixed powder of a quartz powder, boron oxide, sodium oxide, and alumina was melted in a platinum crucible at 1,500° C. for 24 hours so that its feed composition included 64 wt % of SiO₂, 27 wt % of B₂O₃, 6 wt % of Na₂O, and 3 wt % of Al₂O₃. After that, the temperature of the molten glass was lowered to 1,300° C. and the glass was fed into a graphite mold. The glass was cooled in air for about 20 minutes, was kept in a 500° C. annealing furnace for 5 hours, and was then cooled over 24 hours. The resultant block of borosilicate glass was pulverized by using a jet mill until the average particle diameter of the resultant particles reached 4.5 μm, yielding a glass powder 1. The crystallization temperature of the glass powder 1 was 800° C.

### Production Example of Glass Powder 2

A glass powder 2 was produced in the same manner as that for producing the glass powder 1, except that a mixed powder of a quartz powder, boron oxide, and sodium oxide was used so that its feed composition included 63.0 wt % of SiO₂, 28.0 wt % of B₂O₃, and 9.0 wt % of Na₂O, and that the resultant block of borosilicate glass was pulverized by using a wet bead mill until the average particle diameter of the resultant particles reached 2.8 μm. The crystallization temperature of the glass powder 2 was 750° C.

### Production Example of Glass Powder 3

A glass powder 3 was produced in the same manner as that for producing the glass powder 1, except that a block of borosilicate glass having the same feed composition as that of the glass powder 1 was pulverized by using a wet bead mill until the average particle diameter of the resultant particles reached 2.2 μm.

The crystallization temperature of the glass powder 3 was 800° C.

### Production Example of Glass Paste 1

| | |
|---|---|
| Glass powder 1 | 60.0 parts by mass |
| Terpineol | 44.0 parts by mass |
| Ethyl cellulose (registered trademark | 2.0 parts by mass |
| ETHOCEL Std 200 (manufactured by The | |
| Dow Chemical Company)) | |

The above-mentioned raw materials were mixed while being stirred, yielding a glass paste 1. The viscosity of the glass paste 1 was 31,300 mPa·s.

### Production Example of Glass Paste 2

A glass paste 2 was produced in the same manner as that for producing the glass paste 1, except that the glass powder 2 was used in place of the glass powder 1. The viscosity of the glass paste 2 was 38,000 mPa·s.

### Production Example of Glass Paste 3

A glass paste 3 was produced in the same manner as that for producing the glass paste 1, except that the glass powder 3 was used in place of the glass powder 1. The viscosity of the glass paste 3 was 24,600 mPa·s.

### Example of Transparent Substrate

Used as a transparent substrate was a quartz substrate (manufactured by Iiyama Precision Glass Co., Ltd., softening point: 1,700° C., Young's modulus: 72 GPa). Note that the quartz substrate is described as a substrate A below. Note that the substrate A was produced by cutting a quartz substrate having a thickness of 0.5 mm into a piece with a size of 50 mm by 50 mm, followed by mirror polishing. The substrate A had a minimum transmittance of 93% in the wavelength region of 450 nm or more and 650 nm or less.

### Production Example of Structural Body 1

In this example, a structural body having a porous glass layer on a substrate A was produced as follows.

A glass paste 1 was applied on a substrate A by screen printing. MT-320TV manufactured by Micro-tec Co., Ltd. was used as a printer. Further, a solid image of #500 having a size of 30 mm by 30 mm was used as a block.

Next, the resultant was left to stand still in a 100° C. drying furnace for 10 minutes to dry up a solvent content. The thickness of the formed film was measured with SEM and the result was 10.00 μm.

This film was subjected to a heat treatment step 1 in which temperature was increased to 700° C. at a temperature increase rate of 20° C./min and heat treatment was carried out for 1 hour. After that, the film was subjected to a heat treatment step 2 in which temperature was decreased to 600° C. at a temperature decrease rate of 10° C./min and heat treatment was carried out at 600° C. for 50 hours, followed by polishing of the outermost surface of the film, yielding a phase-separated glass layer A.

The phase-separated glass layer A was immersed in a 1.0 mol/L nitric acid aqueous solution heated to 80° C. and was left to stand still at 80° C. for 24 hours. Next, the resultant was immersed in distilled water heated to 80° C. and was left to stand still for 24 hours. Then, the resultant glass body was taken out from the solution, followed by drying at room temperature for 12 hours, yielding a structural body 1.

Observation of its film thickness with SEM confirmed formation of a film having a uniform thickness of 7.00 μm. Table 1 shows the production conditions of the structural body 1. Table 3 shows the measurement results in each evaluation on the resultant structural body 1.

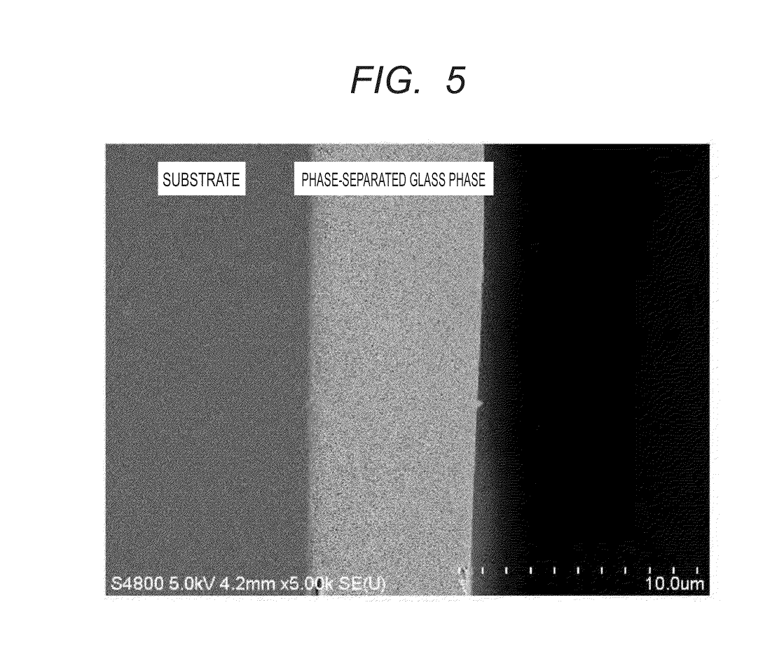

FIG. 5 is an electron microscopic image (SEM image) of a cross section of the substrate and porous glass layer of the structural body 1.

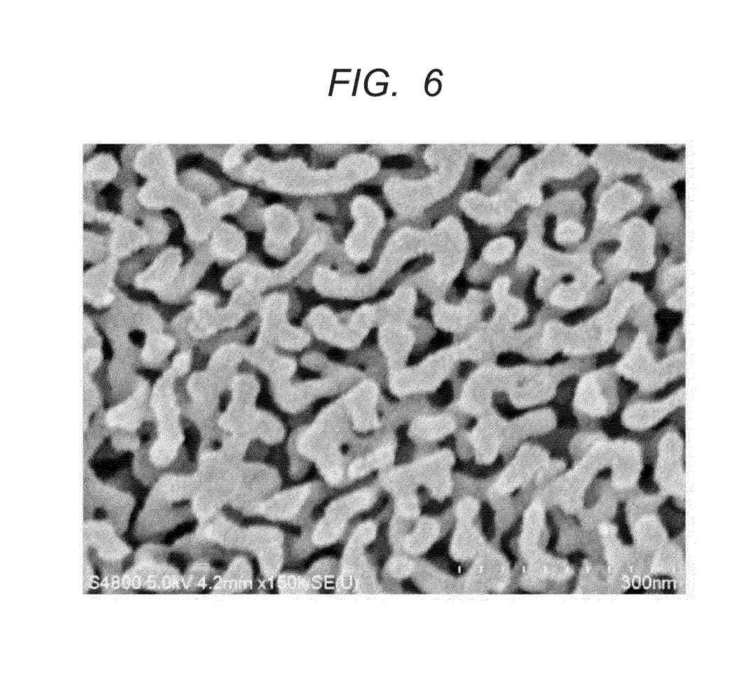

FIG. 6 is an electron microscopic image (SEM image) of a cross section of the porous glass layer of the structural body 1.

### Production Example of Structural Body 2

In this example, a structural body 2 was produced in the same manner as that for producing the structural body 1, except that after the heat treatment step 1 was carried out, temperature was decreased to 575° C. in the heat treatment step 2. Table 1 shows the production conditions of the structural body 2. Table 3 shows the measurement results of the resultant structural body 2.

### Production Example of Structural Body 3

In this example, a structural body 3 was produced in the same manner as that for producing the structural body 1, except that a glass paste used was changed from the glass paste 1 to the glass paste 2 and that, in the heat treatment step 2, temperature was decreased to 600° C. and heat treatment was then carried out at 600° C. for 25 hours. Table 1 shows the production conditions of the structural body 3. Table 3 shows the measurement results of the resultant structural body 3.

### Production Example of Structural Body 4

In this example, a structural body 4 was produced in the same manner as that for producing the structural body 1, except that a glass paste used was changed from the glass paste 1 to the glass paste 3. Table 1 shows the production conditions of the structural body 4. Table 3 shows the measurement results of the resultant structural body 4.

### Production Example of Structural Body 5

In this example, a structural body 5 was produced in the same manner as that for producing the structural body 1, except that the block for screen printing was changed to #200. Table 1 shows the production conditions of the structural body 5. Table 3 shows the measurement results of the resultant structural body 5. Note that voids sufficiently larger than the average pore diameter of pores were confirmed in part of the film of the structural body 5.

### Production Example of Structural Body 6

In this example, a structural body 6 was produced in the same manner as that for producing the structural body 4, except that in the heat treatment step 1, temperature was increased to 800° C. Table 1 shows the production conditions of the structural body 6. Table 3 shows the measurement results of the resultant structural body 6.

### Production Example of Structural Body 7

In this example, a structural body formed of porous glass only was produced as follows.

A mixed powder of a quartz powder, boron oxide, sodium oxide, and alumina was melt in a platinum crucible at 1,500° C. for 24 hours so that its feed composition included 64.0 wt % of SiO₂, 27.0 wt % of B₂O₃, 6.0 wt % of Na₂O, and 3.0 wt % of Al₂O₃. After that, the temperature of the molten glass was lowered to 1,300° C. and the glass was fed into a graphite mold. The glass was cooled in air for about 20 minutes, was kept in a 500° C. annealing furnace for 5 hours, and was then cooled over 24 hours.

The resultant block of borosilicate glass was cut into a piece with a size of 30 mm by 30 mm by 400 μm, followed by mirror polishing of both surfaces, yielding a glass body.

This glass body was subjected to a heat treatment step 1 in which temperature was increased to 700° C. at a temperature increase rate of 20° C./min and heat treatment was carried out for 1 hour. After that, the glass body was subjected to a heat treatment step 2 in which temperature was decreased to 600° C. at a temperature decrease rate of 10° C./min and heat treatment was carried out at 600° C. for 50 hours. After the heat treatment, strain was observed in the glass body. After the outermost surface of its film was polished, the glass body was immersed in a 1.0 mol/L nitric acid aqueous solution heated to 80° C. and was left to stand still at 80° C. for 24 hours. Next, the glass body was immersed in distilled water heated to 80° C. and was left to stand still at 80° C. for 24 hours. Then, the glass body was taken out from the solution, followed by drying at room temperature for 12 hours, yielding a structural body 7. Table 2 shows the production conditions of the structural body 7. Table 4 shows the measurement results of the resultant structural body 7.

### Production Example of Structural Body 8

In this example, a structural body having an irregular structure on the surface of a substrate A was produced in the following manner.

| | |
|---|---|
| Sodium hydrogen carbonate (NaHCO₃, manufactured by Wako | 5.0 g |
| Pure Chemical Industries, Ltd.) | |
| Boron oxide (B₂O₃, manufactured by KISHIDA CHEMICAL | 10.0 g |
| Co., Ltd.) | |
| Pure water | 500.0 g |

A solution having the above-mentioned composition was prepared.

The substrate A was washed with an HCl aqueous solution having a concentration of 1.0 mol/L. After that, the substrate A was immersed in the above-mentioned solution.

The substrate A was then taken out from the solution and was dried in a dryer at 100° C. for 1 hour. Next, the substrate A was placed in an electric furnace, the inside temperature of the electric furnace was increased to 900° C. at a temperature increase rate of 10° C./min, and the substrate A was kept at 900° C. for 10 minutes. After that, the inside temperature was decreased to 700° C. at a temperature decrease rate of 20° C./min, and the substrate A was subjected to furnace cooling while being kept at 700° C. for 3 hours.

After the cooling, the substrate A was immersed for 24 hours in a HCl solution having a concentration of 1.0 mol/L heated to 60° C. After that, the substrate A was subjected to ultrasonic cleaning in pure water for 5 minutes, followed by drying at room temperature, yielding a structural body 8. Table 2 shows the production conditions of the structural body 8. Table 4 shows the measurement results of the resultant structural body 8.

### Production Example of Structural Body 9

In this example, a structural body 9 was produced in the same manner as that for producing the structural body 1, except that the heat treatment conditions were changed to the conditions described in Table 2. That is, this example was different from the production example of the structural body 1 in the respect that the heat treatment step 2 was not carried out and in the heat treatment step 1, temperature was increased to 450° C., followed by heat treatment for 51 hours. Table 2 shows the production conditions of the structural body 9. Table 4 shows the measurement results of the resultant structural body 9.

### Structural Body 10

A construction formed of only a substrate A was defined as a structural body 10. Table 4 shows the measurement results of the structural body 10.

TABLE 1

| | | | Structural | Structural | Structural | Structural | Structural | Structural |
|---|---|---|---|---|---|---|---|---|
| | | | body 1 | body 2 | body 3 | body 4 | body 5 | body 6 |
| Substrate | | Type | Substrate A | Substrate A | Substrate A | Substrate A | Substrate A | Substrate A |
| | | Softening point | 1,700 | 1,700 | 1,700 | 1,700 | 1,700 | 1,700 |
| | | (melting point) | | | | | | |
| Paste | | Type | Paste 1 | Paste 1 | Paste 2 | Paste 3 | Paste 3 | Paste 3 |
| | | Glass | 470 | 470 | 500 | 470 | 470 | 470 |
| | | transition | | | | | | |
| | | temperature | | | | | | |
| | | Crystallization | 800 | 800 | 750 | 800 | 800 | 800 |
| | | temperature | | | | | | |
| Heat | Heat | Temperature | 700 | 700 | 700 | 700 | 700 | 800 |
| treatment | treatment | (° C.) | | | | | | |
| conditions | step 1 | Time (hr) | 1 | 1 | 1 | 1 | 1 | 1 |
| | Heat | Temperature | 600 | 575 | 600 | 600 | 600 | 600 |
| | treatment | (° C.) | | | | | | |
| | step 2 | Time (hr) | 50 | 50 | 25 | 50 | 50 | 50 |

| | | | | | | |
|---|---|---|---|---|---|---|
| Phase separation | 700 | 700 | 700 | 700 | 700 | 800 |
| temperature (° C.) | | | | | | |

TABLE 2

| | | | Structural | Structural | Structural | Structural |
|---|---|---|---|---|---|---|
| | | | body 7 | body 8 | body 9 | body 10 |
| Substrate | | Type | — | — | Substrate A | Substrate A |
| | | Softening point | — | — | 1,700 | 1,700 |
| | | (melting point) | | | | |
| Paste | | Type | — | — | Paste 1 | — |
| | | Glass transition | — | — | 470 | — |
| | | temperature | | | | |
| | | Crystallization | — | — | 800 | — |
| | | temperature | | | | |
| Heat | Heat | Temperature (° C.) | 700 | 900 | 450 | — |
| treatment | treatment | Time (hr) | 1 | 0.2 | 51 | — |
| conditions | step 1 | | | | | |
| | Heat | Temperature (° C.) | 600 | 700 | — | — |
| | treatment | Time (hr) | 50 | 3 | — | — |
| | step 2 | | | | | |

| | | | | |
|---|---|---|---|---|
| Phase separation temperature | 700 | 900 | 450 | — |
| (° C.) | | | | |

TABLE 3

| | | Structural | Structural | Structural | Structural | Structural | Structural |
|---|---|---|---|---|---|---|---|
| | | body 1 | body 2 | body 3 | body 4 | body 5 | body 6 |
| Substrate | Type | Substrate A | Substrate A | Substrate A | Substrate A | Substrate A | Substrate A |
| | Main element | Si | Si | Si | Si | Si | Si |
| | Softening point | 1,700 | 1,700 | 1,700 | 1,700 | 1,700 | 1,700 |
| | (melting point) | | | | | | |
| | Young's modulus | 72 | 72 | 72 | 72 | 72 | 72 |
| | (GPa) | | | | | | |
| Porous | Main element | Si | Si | Si | Si | Si | Si |
| glass | Porosity (%) | 52 | 34 | 66 | 49 | 49 | 50 |
| layer | Pore diameter | 45 | 15 | 90 | 39 | 36 | 38 |
| | (nm) | | | | | | |
| | Skeleton | 30 | 30 | 60 | 42 | 41 | 43 |
| | diameter (nm) | | | | | | |
| | Film thickness | 7.00 | 6.90 | 6.60 | 1.20 | 5.90 | 1.28 |
| | (μm) | | | | | | |

TABLE 4

| | | Structural | Structural | Structural | Structural |
|---|---|---|---|---|---|
| | | body 7 | body 8 | body 9 | body 10 |
| Substrate | Type | — | — | Substrate A | Substrate |
| | | | | | A |
| | Main | — | — | Si | Si |
| | element | | | | |
| | Softening | — | — | 1,700 | 1,700 |
| | point | | | | |
| | (melting | | | | |
| | point) | | | | |
| | Young's | — | — | 72 | 72 |
| | modulus | | | | |
| | (GPa) | | | | |
| Porous | Main | Si | Si | Si | Si |
| glass layer | element | | | | |
| | Porosity | 52 | — | — | — |
| | (%) | | | | |
| | Pore | 35 | — | — | — |
| | diameter | | | | |
| | (nm) | | | | |
| | Skeleton | 30 | — | — | — |
| | diameter | | | | |
| | (nm) | | | | |
| | Film | 380.00 | — | — | — |
| | thickness | | | | |
| | (μm) | | | | |

The resultant structural bodies 1 to 10 were evaluated by the following evaluation means. Tables 5 and 6 show the evaluation results.

### Evaluation of Porous Glass Layer

A scanning electron microscope (FE-SEM S-4800, manufactured by Hitachi, Ltd.) was used to photograph SEM images (electron micrographs) at an accelerating voltage of 5.0 kV at magnifications of from 10,000 times to 150,000 times. The photographed images were used to determine the presence or absence of a porous glass layer on the substrate.

Rank A: A porous glass layer is found on the substrate.

Rank B: No porous glass layer is found on the substrate.

### Evaluation of Pore Structure

A scanning electron microscope (FE-SEM S-4800, manufactured by Hitachi, Ltd.) was used to photograph SEM images (electron micrographs) at an accelerating voltage of 5.0 kV at magnifications of from 10,000 times to 150,000 times. The photographed images were used to determine the presence or absence of a porous structure having continuous pores produced by spinodal-type phase separation.

Rank A: A porous structure having continuous pores produced by spinodal-type phase separation is found in a whole porous glass layer.

Rank B: A porous structure having continuous pores produced by spinodal-type phase separation is partially found in a porous glass layer.

Rank C: A porous structure having continuous pores produced by spinodal-type phase separation is not found.

### Evaluation of Strain of Structural Body

Evaluation of strain of a structural body was performed based on the following criteria. A structural body was placed on a flat table and strain of the structure was determined based on whether or not the structure had warpage.

Rank A: Warpage of a structural body is not found.

Rank B: Warpage of a structural body is found.

### Evaluation of Strength

Two opposite sides of a resultant structural body were fixed at each portion with a length of 10 mm, and a 100-g weight with an area of 10 mm by 10 mm was put on the center of the structural body. The strength of the structural body was evaluated based on whether or not the structural body was broken.

Rank A: A structural body is not broken.

Rank B: A structural body is broken.

### Evaluation of Adhesiveness of Porous Glass Layer

An interface between the porous glass layer portion and the transparent substrate of a resultant structural body was observed by using SEM to evaluate the film adhesiveness. Evaluation criteria are as described below.

Note that a field emission scanning electron microscope S-4800 (product name) manufactured by Hitachi High-Technologies Corporation was used as an apparatus, and observation was conducted at an accelerating voltage of 5.0 kV at a magnification of 150,000 times. Specifically, the film adhesiveness was determined based on whether or not the interface between the skeleton portion of the porous glass layer and the transparent substrate was observed.

Rank A: A porous glass portion and a transparent substrate are not separated.

Rank B: A porous glass portion and a transparent substrate are separated.

### Evaluation of Degree of Progress of Etching

A fracture surface of a resultant structural body was observed by using SEM to evaluate the degree of progress of etching from the surface direction. Detailed evaluation criteria are as mentioned below.

Note that a field emission scanning electron microscope S-4800 (product name) manufactured by Hitachi High-Technologies Corporation was used as an apparatus, and observation was conducted at an accelerating voltage of 5.0 kV at a magnification of 150,000 times.

A cross section of a porous glass layer to which heat treatment for phase separation had been performed was exposed, and etching was carried out in the same conditions as those for producing structural bodies, followed by SEM observation. Because etching is carried out from a cross section, it is possible to confirm a true skeleton structure.

Specifically, a whole glass layer was divided into ten pieces in the film thickness direction, the diameters of 30 pores were measured as a distance from the surface of each layer, and the average value of the diameters was defined as the pore diameter at the depth.

Next, the fracture surface of the structural body was observed and the pore diameter was calculated in the same manner as described above.

The diameter of a pore produced by etching from the cross section and the diameter of a pore in the structural body were compared based on each site at which the distance from each layer surface was the same. When there was a difference in pore diameter by 5 nm or more at certain compared sites, it was determined that etching was not progressed in the site of the structural body. Further, the structure structural body 7 was evaluated in the same manner as described above based on the assumption that the whole structural body was one single layer.

Rank A: Etching is progressed up to the inside of a layer.

Rank B: Etching is not partially progressed in the inside of a layer.

### Evaluation of Transmittance

An automatic optical device measurement apparatus (V-570, manufactured by JASCO Corporation) was used to measure the transmittance of each structural body at every 1 nm in the wavelength region of 450 to 650 nm. The light incident angle in the transmittance measurement was set to 0°. The minimum transmittance in the range was used as the transmittance of each structural body.

### Evaluation of Surface Reflectivity

A lens spectral reflectivity measurement instrument (USPM-RU, manufactured by Olympus Corporation) was used to measure the surface reflectivity of each structural body at every 1 nm in the wavelength region of 450 to 650 nm. The maximum reflectivity in the range was used as the reflectivity of each structural body.

### Evaluation of Scattering Characteristic

A sample was observed while angles to a plane of a structural body were being altered to change viewpoints starting from the vertical direction with respect to the plane, thereby visually confirming the degree of light scattering.

Rank A: Whitening due to light scattering is not at such a level as to cause any problem.

Rank B: Whitening due to light scattering is observed.

Rank C: Whitening due to light scattering is remarkable.

TABLE 5

| | | Example 1 | Example 2 | Example 3 | Example 4 | Example 5 | Example 6 |
|---|---|---|---|---|---|---|---|
| | | Optical | Optical | Optical | Optical | Optical | Optical |
| | | member 1 | member 2 | member 3 | member 4 | member 5 | member 6 |
| Evaluation of | Porous glass | A | A | A | A | A | A |
| characteristics | layer | | | | | | |
| | Fine pore | A | A | B | A | B | B |
| | structure | | | | | | |
| | Strain | A | A | A | A | A | A |
| | Strength | A | A | A | A | A | A |
| | Adhesiveness | A | A | A | A | A | A |
| | of glass | | | | | | |
| | layer | | | | | | |
| | Degree of | A | A | A | A | A | A |
| | progress of | | | | | | |
| | etching | | | | | | |
| Evaluation of | Transmittance | 80 | 89 | 50 | 91 | 64 | 65 |
| optical | Reflectivity | 2.3 | 1.9 | 3.1 | 2.9 | 2.0 | 0.8 |
| physical | Scattering | A | A | B | A | A | B |
| properties | | | | | | | |

TABLE 6

| | | Comparative | Comparative | Comparative | Comparative |
|---|---|---|---|---|---|
| | | example 1 | example 2 | example 3 | example 4 |
| | | Optical | Optical | Optical | Optical |
| | | member 7 | member 8 | member 9 | member 10 |
| Evaluation of | Porous glass layer | C | C | C | C |
| characteristics | Fine pore structure | C | C | C | C |
| | Strain | B | A | A | A |
| | Strength | B | A | A | A |
| | Adhesiveness of glass layer | — | — | B | — |
| | Degree of progress of etching | B | — | — | — |
| Evaluation of | Transmittance | Unmeasurable | 84 | 1 | 93 |
| optical physical | Reflectivity | Unmeasurable | 3.6 | Unmeasurable | 3.5 |
| properties | Scattering | Unmeasurable | B | C | A |

The structural bodies 1 to 6 are applicable as optical members each having high strength, low reflection, and a high transmittance.

The structural body 7 had very low strength and remarkable strain, and hence it was not possible to perform the evaluations of its transmittance, surface reflectivity, and scattering characteristic while its originally produced state was maintained.

Further, the structural body 9 had a very large degree of scattering, and hence it was impossible to obtain the value of a surface reflectivity.

### REFERENCE SIGNS LIST

101, 201 optical member
102, 202 porous glass layer
103, 203 transparent substrate

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2010-263754, filed Nov. 26, 2010, No. 2011-146513 filed Jun. 30, 2011, and No. 2011-230002 filed Oct. 19, 2011 which are hereby incorporated by reference herein in their entirety.

1. An optical member, comprising:
a transparent substrate; and
a porous glass layer having a three-dimensional mesh hole-shaped through pores disposed on the transparent substrate,
wherein optical member has a transmittance of 50% or more in a wavelength region of 450 nm or more and 650 nm or less.

2. The optical member according to claim 1, wherein the pore diameter of the pore formed in the porous glass layer is 1 nm or more and 50 nm or less.

3. The optical member according to claim 1, wherein the skeleton diameter of the skeleton of the porous glass layer is 1 nm or more and 50 nm or less.

4. The optical member according to claim 1, wherein the porous glass layer has a porosity of 30% or more and 70% or less.

5. The optical member according to claim 1, wherein the porous glass layer has a thickness of 0.05 μm or more and 200.00 μm or less.

6. The optical member according to claim 1, wherein the transparent substrate has a Young's modulus of 40 GPa or more.

7. The optical member according to claim 1, wherein a main element forming the transparent substrate is the same as a main element forming the porous glass layer.

8. The optical member according to claim 1, wherein at least one of a pore diameter of a pore formed in the porous glass layer and a skeleton diameter of a skeleton of the porous glass layer is set so that the optical member has a transmittance of 50% or more in a wavelength region of 450 nm or more and 650 nm or less.

9. The optical member according to claim 1, wherein the transparent substrate includes quartz glass.

10. The optical member according to claim 1, wherein the transparent substrate includes crystal.

11. An imaging apparatus, comprising the optical member according to claim 1 and an imaging device.

12. The imaging apparatus according to claim 11, wherein the optical member is disposed so that the porous glass layer is farther from the imaging device than the transparent substrate.
